(19) United States
(12) Patent Application Publication
(10) Pub. No.: US 2009/0091269 A1
(43) Pub. Date: Apr. 9, 2009

(54) High Frequency Pulsed Supply For Discharge Lamps

(75) Inventors: Arnoldo Jose Perin, Florianopolis (BR); Joao Vilela, JR., Florianopolis (BR)

Correspondence Address: HEDMAN & COSTIGAN P.C., 1185 AVENUE OF THE AMERICAS, NEW YORK, NY, 10036, US

(73) Assignee: UNIVESIDADE FEDERAL DE SANTA CATARINA

(21) Appl. No.: 12/295,923

(22) PCT Filed: Apr. 4, 2007
(86) PCT No.: PCT/BR07/00081

§ 371 Date: Oct. 3, 2008

(30) Foreign Application Priority Data
Apr. 6, 2006 (BR) PI 0601239-6

(51) Int. Cl. H05B 41/36; H05B 41/14

(52) U.S. Cl. 315/250; 315/297

(57) ABSTRACT

The HIGH FREQUENCY PULSED SUPPLY FOR DISCHARGE LAMPS describes electronic converters for discharge lamps with high frequency pulsed current stabilization. A voltage inverter is employed either in a Full-Bridge configuration using peak current control or in a Half-Bridge configuration with a capacitive element. These converters allow the luminous intensity of the lamp to vary (dimming), as well as the frequency of the pulses over a wide frequency range, avoiding acoustic resonance to appear; they also allow a low frequency power variation, aiming to improve the color rendering index and correlated color temperature properties of the light emitted by certain types of discharge lamps, such as the high pressure sodium lamps. The converters present a significant reduction in the volume of the power circuit due to the removal of the magnetic element, being even more attractive as the power of the lamp increases.

The HIGH FREQUENCY PULSED SUPPLY FOR DISCHARGE LAMPS describes electronic converters for discharge lamps with high frequency pulsed current stabilization. A voltage inverter is employed either in a Full-Bridge configuration using peak current control or in a Half-Bridge configuration with a capacitive element. These converters present a significant reduction in the volume of the power stage due to the removal of the magnetic element; they allow the luminous intensity of the lamp to vary (dimming), as well as the frequency of the pulses over a wide frequency range, avoiding acoustic resonance to appear; they also allow a low frequency power variation, aiming to improve the color appearance of the light emitted by certain types of discharge lamps, such as the high pressure sodium lamps.

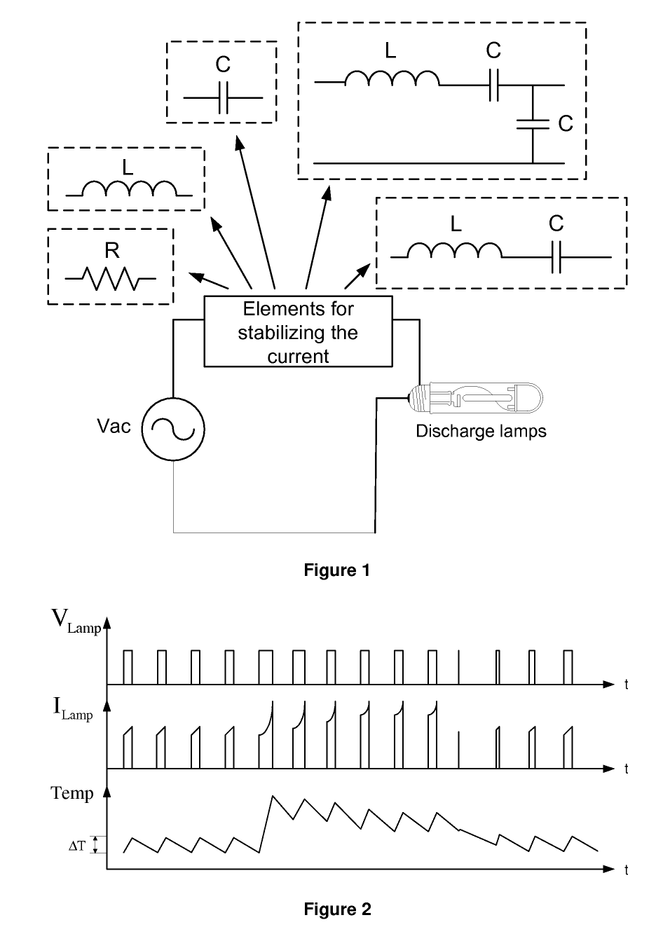

Normally, metal halide lamps, high pressure sodium lamps, fluorescent lamps and discharge lamps in general employ series elements for stabilizing the current. Under sinusoidal operation at low frequency (50 or 60 Hz), an inductor or a capacitor is usually placed in series with the lamp. For ballasts operating at high frequency, LC or LCC are employed for stabilizing the current through the lamp (FIG. 1), otherwise, the current would increase up to very high values (“short circuit”).

Low frequency operation with an inductor or capacitor in series with the lamp requires heavy and bulky components. Undesired characteristics, such as the stroboscopic effect are present in this type of supply. A high frequency supply using an output filter solves the problem associated with the stroboscopic effect, but the magnetic element at the output still has a considerable weight and volume.

Therefore, discharge lamps that employ electronic ballasts are normally fed by a limited current with low frequency square wave in order to avoid acoustic resonance. This type of supply requires a large number of stages in the converter and, as a consequence, increases the cost and volume of the equipment and reduces both the performance and reliability.

The technique described in this report is based on the use of current pulses of short duration. Thus, the current does not vary abruptly, since it depends on the temperature of the plasma. This technique was presented in the patent of Pacholok D. R. in 1990 under the title: “Ballast for high intensity discharge lamps”, U.S. Pat. No. 4,904,903. The novelty here is that a simple solution was found to implement thus technique by using a high performance, low cost single-stage converter. Furthermore, in case a capacitor is placed in series with the lamp as a current stabilizer element, it is possible to impose constant power in open-loop, which is completely different from any other technique.

High frequency pulses were first used by Ben-Yaakov, S. and Shvartsas, M. in March 2001 at the Applied Power Electronics Conference and Exposition—APEC 2001, Volume 2, pp. 670-675, entitled: “An electronic ballast for fluorescent lamps with no series passive elements”. The technique used in this paper considers only applications for compact fluorescent lamps which have slower temperature variations than high pressure discharge lamps. Furthermore, closed-loop control is implemented which imposes the average of the current through the lamp, a condition that is only possible for the type of lamp used. In other words, the idea presented in the aforementioned publication cannot be used for fluorescent lamps, even though it does not employ passive elements in series with the lamp. This is similar to the Full-Bridge configuration, technique presented in this patent, but in this case closed-loop peak current control is used.

The high frequency pulsed supply for discharge lamps that is being proposed employs a single high frequency stage, which allows the amplitude of the current pulses to be reduced and improves the performance without generating acoustic noise problems. Besides that, it allows all the passive elements in series with the lamp to be removed or a single capacitor to be used as the stabilizing element in series with the lamp.

Additionally, the proposed technique that employs a capacitor as the stabilizing element allows the lamp to be supplied by constant power, in open-loop, independent of the parametric variations that may happen to the lamp as a consequence of temperature or age. This is an innovative characteristic when compared to the currently known solutions which require closed-loop control to ensure constant power due to the variation of the equivalent resistance of the lamp as a consequence of its aging process.

The use of the high frequency pulsed supply with no magnetic element in series with the lamp, as is being proposed, allows the number of stages of the converter to be reduced, thus, reducing the cost, weight and volume and also increasing the reliability due to the decrease in the number of components of the power circuit. To complement the description of the novel idea and for an easy understanding of its characteristics, some figures are presented for illustrative purposes but are not limited to these:

FIG. 1—Current stabilizing elements for high pressure discharge lamps.

FIG. 2—Theoretical voltage, current and temperature behavior of the discharge lamp using peak current control, with no stabilizing element in series with the lamp.

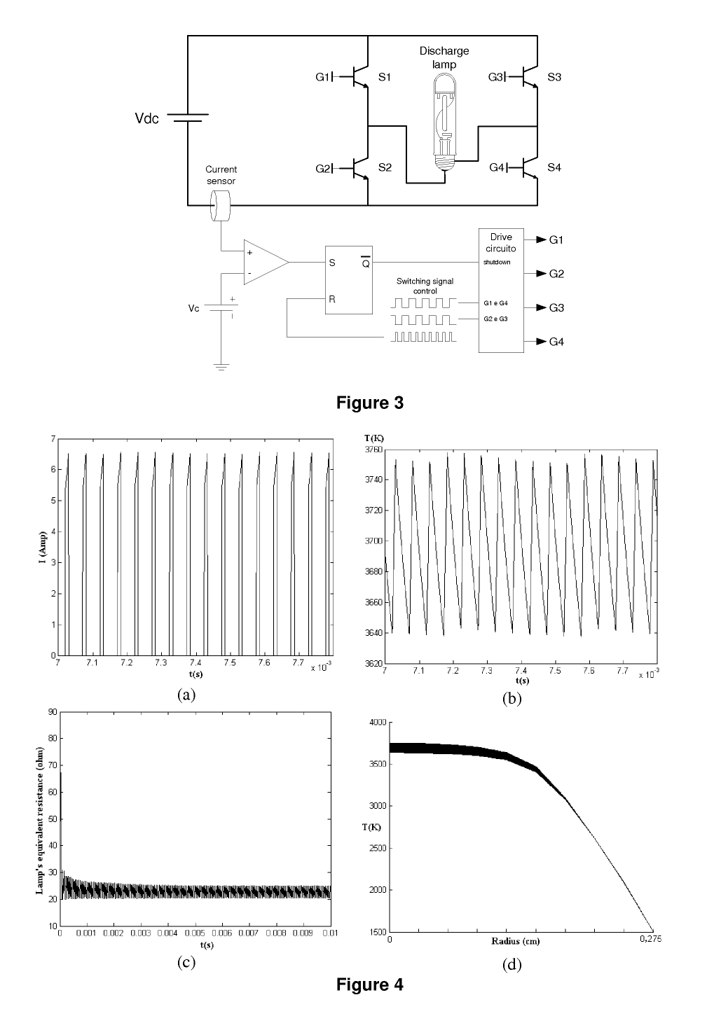

FIG. 3—Electrical schematic of the converter that allows the use of the peak current control method.

FIG. 4—Simulation results obtained using the peak current control technique. a) current through the lamp; b) temperature profile; c) equivalent resistance of the lamp; d) axial temperature profile inside the discharge tube.

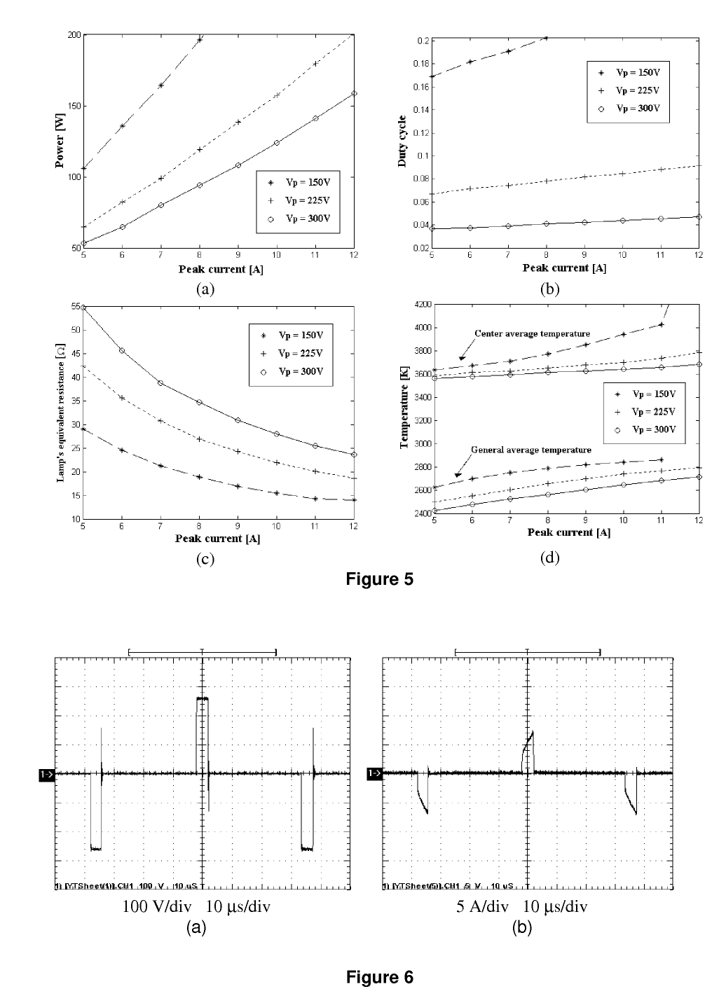

FIG. 5—Behavior of the main quantities of the lamp as a function of the peak current, for distinct voltage source values.

FIG. 6—Experimental results obtained using the peak current control method, for a 150 W high pressure sodium (HPS) lamp.

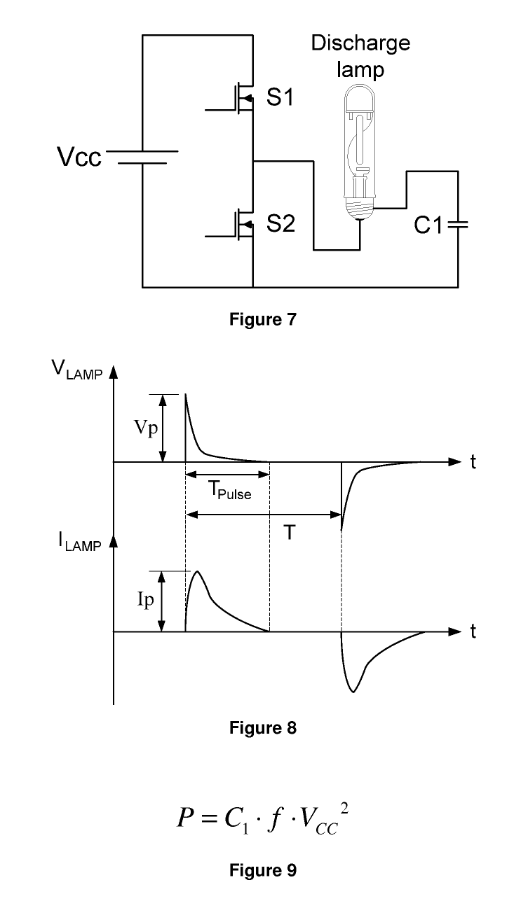

FIG. 7—Circuit designed to supply high frequency pulsed current to the discharge lamps.

FIG. 8—Theoretical voltage and current waveforms of the lamp using the converter illustrated in FIG. 7.

FIG. 9—Equation that establishes the power control variables of the lamp.

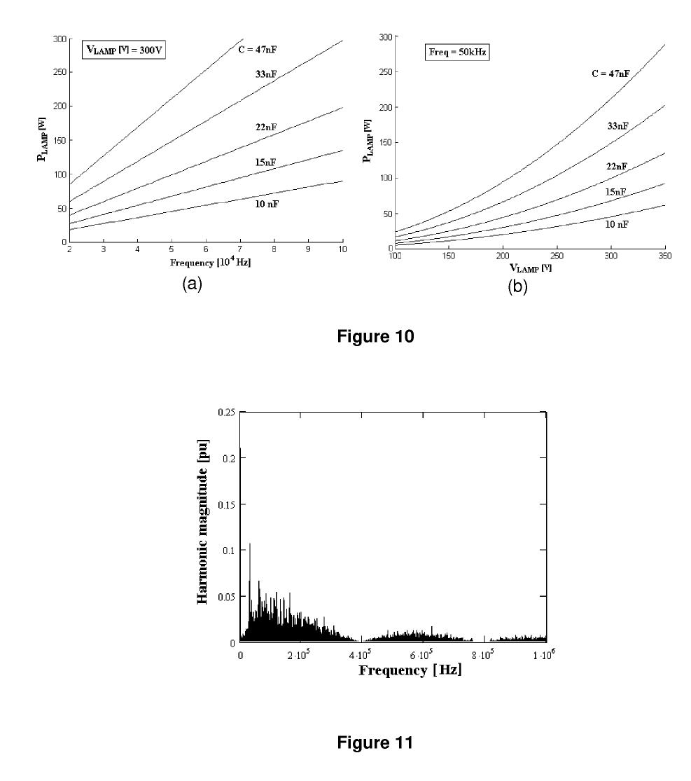

FIG. 10—Graphs that present the behavior of the power in the lamp as a function of the pulse frequency and as a function of the voltage across the lamp for different values of capacitor C1 of FIG. 7.

FIG. 11—Magnitude of the voltage harmonic components across the lamp with the random switching frequency variation ranging from 16 to 24 kHz.

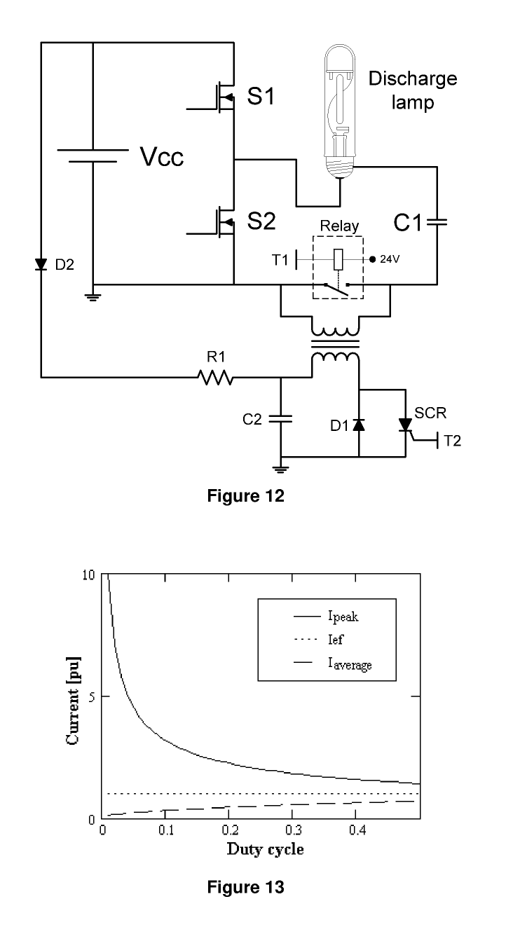

FIG. 12—Schematic of the converter of FIG. 7 with an ignition circuit included.

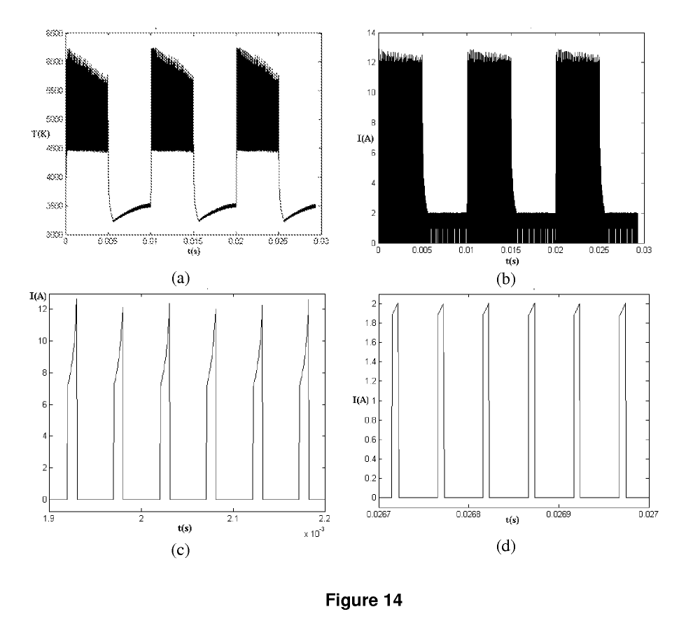

FIG. 13—Peak, rms and average currents of the lamp as a function of the duty cycle.

FIG. 14—a) Temperature at the center of the arc; b) low frequency current envelope; c) high frequency pulsed current with a high peak value; d) high frequency pulsed current with a low peak value.

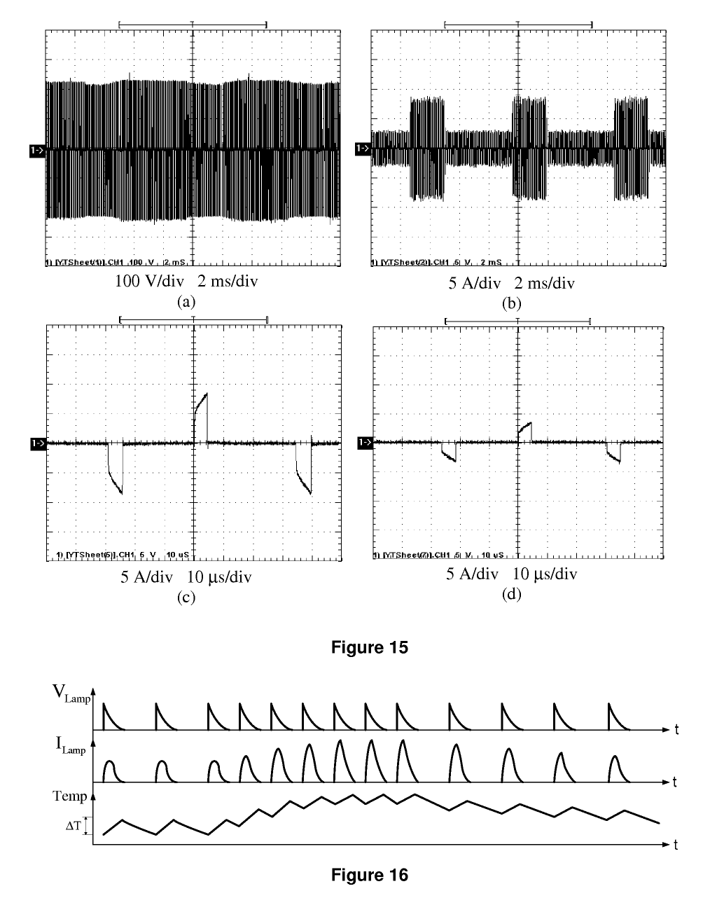

FIG. 15—Experimental results obtained using the Full-Bridge converter operating at high frequency and modulated at low frequency using peak current control. a) low frequency voltage waveform; b) low frequency current envelope; c) high frequency current waveform with a high peak value; d) high frequency current waveform with a low peak value.

FIG. 16—Theoretical waveforms of the behavior of the lamp using the high frequency pulsed current modulated at low frequency method for the structure presented in FIG. 7.

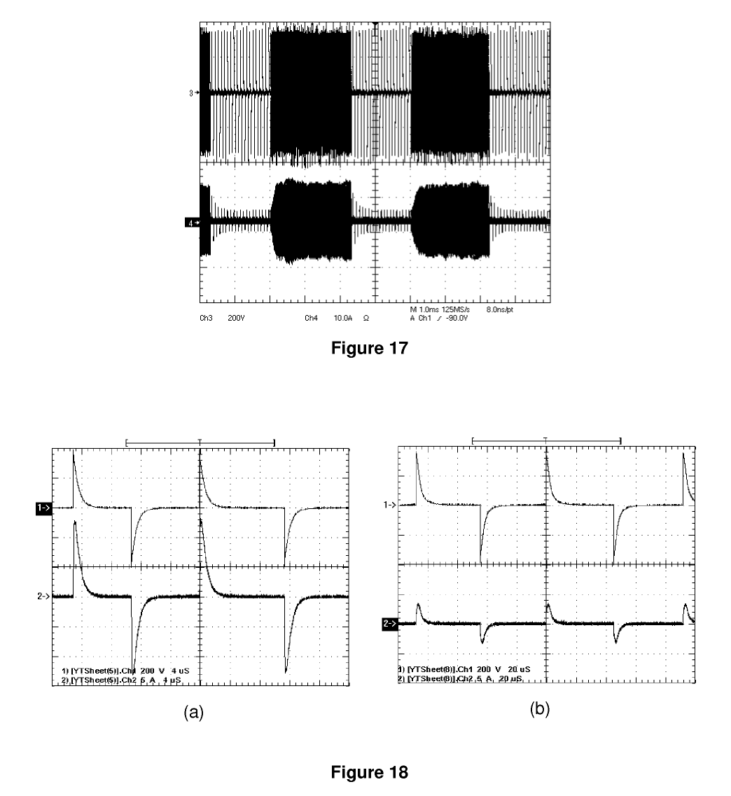

FIG. 17—Current and voltage waveforms obtained from a 150 W lamp with high frequency pulsed current modulated at low frequency using the structure presented in FIG. 7.

FIG. 18—Current and voltage obtained from a 150 W lamp when supplied by two distinct frequencies, using the structure presented in FIG. 7.

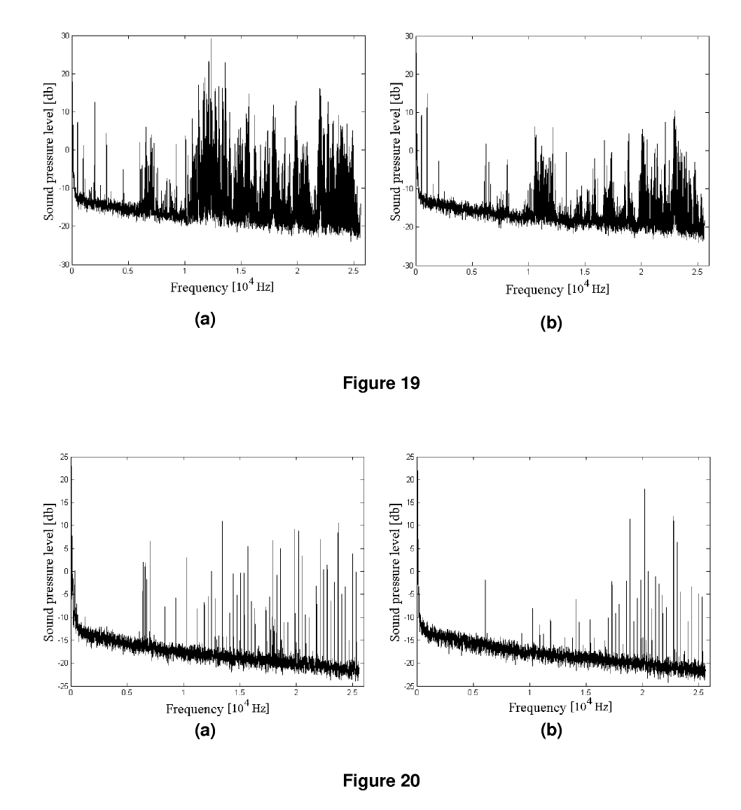

FIG. 19—Acoustic noise spectrum generated by Osram Vialox NAV-E 150 W and a NAV-T 150 W lamp, with high frequency current modulated at 500 Hz.

FIG. 20—Acoustic noise spectrum generated by Osram Vialox NAV-E 150 W and a NAV-T 150 W lamp, without low frequency modulation.

The high frequency pulsed supply for discharge lamps can be obtained by using a Full-Bridge inverter with high frequency peak current control and without using stabilizing elements in series with the lamp. The control of the temperature of the arc is achieved by controlling the current through the lamp, knowing that the increase in current is a function of the dynamic variation of the conductivity of the plasma, which is a function of the temperature. By Plasma meaning the high temperature substances inside the discharge tube of the lamp that favors the generation of the electric arc.

Applying voltage pulses of width much smaller than the time required for significant variations in the conductivity of the plasma to occur, allows a current control loop for the lamp to be implemented. This control loop does not allow the current to increase excessively.

When the inverter operates at frequencies above 10 kHz, the temperature of the arc inside the lamp suffers a small variation over a switching period, and, as a consequence, the conductivity of the plasma remains practically constant, allowing the voltage pulses to be applied to the lamp without the need for a stabilizing passive element to be placed in series. When the voltage pulse is applied, a rapid increase in the temperature of the arc is expected. However, this temperature increase is not very significant due to the short duration of the pulse brought about by the high frequency and low duty cycle. The cooling time of the arc is also short due to the high frequency, thus, the temperature of the arc only varies slightly.

Presented in FIG. 2 are, the theoretical voltage and current waveforms of the lamp and the temperature at the center of the discharge tube, when using a high frequency pulsed supply with peak current control and without a current stabilizing element in series with the lamp.

In the pulsed supply without any current stabilizing elements in series with the lamp, the main factor that limits the current is the conductivity of the plasma, which is a function of the radial temperature profile inside the discharge tube. In this manner, increasing the peak current implies an increase in the temperature inside the discharge tube. Controlling the current allows the temperature to be indirectly controlled.

The proposed temperature control technique consists of controlling the current's peak value and the frequency of the pulses. FIG. 3 shows the schematic diagram of one of the possible electrical circuits which can be used to implement the peak current control method. The circuit operates as follows: A voltage pulse is applied so that the current increases. When the current reaches a certain value, the voltage pulse is removed so that the arc cools. The lamp will be again submitted to a voltage pulse, using peak current control, after the time interval defined by the control has elapsed.

The variation of the temperature of the arc depends on the operating frequency; the higher the operating frequency, the smaller the temperature variation in the arc will be. The temperature of the arc around which the lamp will oscillate, depends on the peak value of the current, which is defined as a function of the power transferred to the lamp.

Using peak current control guarantees that the temperature of the arc will stabilize due to the behavior of the plasma. When the temperature of the arc is below the desired value, the duty cycle increases due to the longer amount of time it takes for the current to reach its peak value, thus supplying more power to the lamp and, as a consequence, heating occurs. On the other hand, when the temperature of the arc inside the lamp is very high, its initial conductivity is high, which decreases the duty cycle and the amount of power required to reach the peak current value. This variation of the duty cycle when using peak current control stabilizes the current, when operating at high frequency.

To visualize this behavior a computer simulation was performed using a complete model for the high pressure sodium (HPS) lamp. FIG. 4(a) presents the waveforms of the current through the lamp when operating at 20 kHz, with a peak current of 6.5 A and with of 150 V voltage pulses. From FIG. 4(b) it is possible to verify the stabilization dynamics of the temperature of the arc inside the discharge tube, which does not present well defined maximum and minimum temperature values, but, instead, a small variation. These variations do not lead to instability because of the variation in the duty cycle, which maintains the temperature within an operating range.

Under this operating condition, the duty cycle was around 18.7% and the power transferred to the lamp was approximately 150.4 W. The average temperature at the center of the discharge tube was 3,692 K and the overall average temperature inside the discharge tube was 2,723 K.

FIGS. 4(c) and 4(d) show the behavior of the equivalent resistance of the lamp, which stabilizes around 22.7Ω, and the radial temperature profile inside the discharge tube.

Still using the model, it is possible to create graphs that illustrate the behavior of the lamp as the peak current varies. The variation of the active power supplied to the HPS lamp as a function of the peak current value has a quasi-linear behavior, as can be observed in FIG. 5(a). The angular coefficient of this line is inversely proportional to the amplitude of the voltage pulse.

The variation of the duty cycle is barely affected by the peak current value because the current increases exponentially. The factor that most significantly affects the duty cycle is the pulse voltage value. FIG. 5(b) shows the behavior of the duty cycle as a function of the peak current for different voltage pulse amplitudes.

The increase in the active power supplied to the HPS lamp causes a reduction in its equivalent resistance due to heating. FIG. 5(C) presents the variation of the equivalent resistance of the HPS lamp as a function of peak current value.

The current increase increases the active power supplied to the lamp and, consequently, heats the inside of the discharge tube. FIG. 5(d) shows the variation of the overall average temperature and the average temperature at the center of the discharge tube as a function of the peak current value.

FIG. 6 presents the experimental results obtained for an operating condition of a 150 W HPS lamp in which the amplitude of the voltage pulses is approximately 260 V. Under this operating condition, it takes about 4 μs for the current to reach its peak value. The peak current values were defined to transfer rated power to the lamp.

The pulsed supply of the discharge lamp using the Full-Bridge inverter with peak current control proved to be an efficient technique for stabilizing the current. However, this supply technique requires a complex control circuit to monitor the voltage and the current of the lamp. In order to simplify the control circuit, a capacitor was placed in series with the lamp, originating the topology described next.

The proposed topology simplifies the use of the pulsed current supply for the lamp and presents a reduced number of switches and an increase in robustness when compared to the topology presented in FIG. 3. FIG. 7 presents the Half-Bridge inverter using the pulsed supply. This inverter operates as follows: considering the voltage across capacitor C1 to be equal to the source (Vcc), switch S2 is turned on so that capacitor C1 is discharged by the circuit formed by switch S2 and the lamp.

Once the discharge process of capacitor C1 is over, no current circulates through the lamp until switch S2 is blocked and switch S1 is turned on. When switch S1 is turned on, capacitor C1 is charged by a current circulating from source Vcc and through the lamp. When the voltage across capacitor C1 equals the source voltage, the circulation of current through the lamp ceases.

This operating mode imposes an alternating current through the lamp ensuring that the average current through the lamp is zero, thus avoiding the cataphoresis effect. Furthermore, the switches turn off under zero current conditions.

FIG. 8 shows the theoretical voltage and current waveforms of the lamp. The voltage across the lamp decays exponentially, complementary to the voltage increase across capacitor C1. The current presents a slightly different behavior than that of the voltage, as a consequence of the variation of the conductivity of the plasma inside the discharge tube. However, the variation of the conductivity of the plasma during a pulse is small, due to the short duration of the pulses.

The pulse width (Tpulse) and the current amplitude (Ip) depend on the equivalent resistance of the lamp. The smaller the equivalent resistance of the lamp, the smaller the pulse width and the greater the amplitude of the current will be.

Since capacitor C1 is charged and discharged every switching cycle, the power supplied to the lamp is a function of the operating frequency of the inverter, the capacitance and source voltage, as can be observed in the equation presented in FIG. 9.

If the minimal switching period of the inverter is larger than the pulse width, the capacitor will charge to voltage Vcc and will be fully discharged every operating cycle. Under this operating condition, the power can be controlled in open-loop once the supply voltage of the inverter and the operating frequency are known.

Inserting a power factor correction stage that regulates the output voltage (voltage Vcc in FIG. 7), it is possible to maintain voltage Vcc at a constant value. In this manner, the power of the inverter depends solely on one variable: the operating frequency of the inverter, which is defined by the control algorithm itself.

In this manner, it is observed that the power supplied to the lamp is controlled in open-loop, eliminating the need for current and voltage sensors for the lamp. With this technique and the proposed structure, the power is not a function of the lamp and does not depend on its parametrical variations, caused by the temperature or the aging of the lamp.

FIG. 10(a) shows the behavior of the power as the frequency varies when the supply voltage is kept constant. This graph shows that it is possible to significantly vary the power of the lamp by varying the frequency of the inverter. This characteristic allows the luminous intensity of the lamp to be varied (dimming) by varying the frequency.

The power supplied to the lamp is very sensitive to voltage variations, as can be observed in FIG. 10(b).

The high frequency supply for the discharge lamps may cause the formation of stationary waves inside the discharge tube, which deform the arc and compromise the efficiency of the lamp.

For the acoustic resonance to occur the supply frequency must coincide with one of the resonant frequencies of the lamp and the amplitude of the current at this frequency must be above the threshold value required for acoustic resonance to occur. In this manner, it is proposed a supply strategy for the lamp that will distribute the frequency spectrum, thus minimizing the amplitude of the harmonics below the threshold value required for acoustic resonance to occur.

An efficient manner to spread the frequency spectrum is to supply the lamp with current pulses of random frequency within a large frequency range. FIG. 11 presents the frequency spectrum obtained by randomly varying the frequency of the pulses within a range that extends from 16 kHz to 24 kHz. The small magnitude of the harmonic components proves the efficiency of this technique.

The absence of a magnetic element allows the frequency of the inverter to be varied over a very large range, which makes the good distribution of the frequency spectrum of the current supplied to the lamp possible.

The discharge lamps require high voltages to ionize the gas and form the arc. This characteristic of the lamp's ignition can be satisfied by using transformers. However, they are removed from the supply circuit of the lamp to avoid interference with the pulsed supply.

FIG. 12 presents one of the possible ignition circuit, which has reduced volume since the energy processed by it is low. A transformer with a small core can be employed since it will only be used during a few microseconds when the ignition pulse is applied to the lamp.

The ignition circuit operates in the following manner: initially capacitor C2 is charged with a voltage equal to Vcc. A signal is sent through T2 for the commutation of the thyristor, which applies the voltage across capacitor C2 to the primary of the transformer, which, in turn, generates a high voltage at the secondary winding of the transformer and across the lamp, causing the gas to ionize and the discharge to start.

After the ignition pulse, a signal orders the closing of relay 1 which removes the ignition transformer from the supply circuit of the lamp. The ignition control circuit, as well as the random pulses generated for the switches, can be implemented by using a simple microprocessor, e.g., PIC16F716.

For pulsed supply, the lower the duty cycle, the higher the peak current and the smaller the average current to maintain a constant rms current, which, in a similar fashion, also occurs for the voltage. FIG. 13 illustrates this behavior.

Pulsed supply requires that the switches bear peak currents higher than the sinusoidal supply. However, the average current of the switches is smaller than the sinusoidal supply, making the use of IGBTs more attractive, since they will present lower conduction losses. Since zero current switching occurs, the tail current, normally seen in IGBTs, will not be an issue.

Both of the inverters allow the use of low frequency power modulation.

The high frequency pulsed supply allows the lamp to operate without a current stabilizer. However, the temperature at the center of the discharge tube suffers small variations and, as a consequence, the axial temperature profile is practically unaltered. Under these operating conditions, the highest energy levels of sodium and mercury are not excited, causing the light that is emitted to present a low color rendering index.

In order to improve the color appearance of the light that is emitted by the HPS lamps, it is necessary that the temperature at the center of the discharge tube change substantially. One of the ways to achieve a large temperature variation is to supply the lamp with low frequency pulses. However, this operation mode requires a current limiter to be placed in series with the lamp.

In order to provide a large temperature variation without using a current limiter, a high frequency supply with power modulated at low frequency is proposed. Peak current control using two different current levels can be used for the Full-Bridge inverter. During the period in which is necessary to keep alive the arc, a small peak current is defined that does not cause a significant heating of the plasma, similar to the “current simmer” of the low frequency pulsed supply, except now pulsed at high frequency. When it is desirable to increase the temperature of the arc, a much higher peak current is defined, which corresponds to the pulse of the low frequency pulsed supply method.

Using the lamp model equations, it is possible to verify the behavior of the HPS lamp when using the high frequency pulsed supply with the power modulated at low frequency.

Example: An inverter operating at 20 kHz with voltage pulses of 150 V is used. The modulation frequency is 100 Hz, with a pulse width of 5 ms (the pulse width of the modulating signal). At the operating time which corresponds to the pulse for the low frequency modulating signal (interval during which the lamp is submitted to high current pulses), the peak current is equal to 12 A. During the interval which corresponds to the simmer current for the low frequency modulating signal, the peak current is 2 A.

FIG. 14(a) shows the behavior of the temperature at the center of the discharge tube using the proposed modulation technique. FIG. 14(b) shows simulation results of the behavior of the current supplied to the lamp. FIG. 14(c) and FIG. 14(d) show, in detail, the behavior of the current of the lamp when using 12 A and 2 A peak currents, respectively.

FIG. 15(a) and FIG. 15(b) show the waveforms of the supply voltage and current when the frequency varies between 17 kHz and 24 kHz, with a modulating frequency of 145 Hz and a duty cycle of 0.33. The 150 W HPS lamp was supplied by 220 V voltage pulses. Under this operating condition the rms voltage across the lamp was 93.5 V, the rms current was 1.96 A, and the average power supplied to the lamp was 156 W.

FIG. 15(c) shows the waveform of the current through the lamp during the interval in which the lamp is subjected to high currents (“pulse”). FIG. 15(d) shows the waveform of the current during the interval in which the peak current is low (“current simmer”).

Note that the duty cycle of the pulses did not suffer a large variation between the two operating modes. However, the initial current values are very different, revealing that the arc temperature is significantly changing due to the modulation.

Using the Half-Bridge inverter the low frequency power modulation can be achieved by varying the frequency of the pulses, which causes a variation in the power supplied to the lamp.

It is possible to emulate the pulse current and the simmer current of the low frequency pulsed supply by making the inverter operate at two distinct frequencies. FIG. 16 presents the theoretical waveforms of the voltage, current, and temperature at the center of the discharge tube, when the lamp is supplied by high frequency pulses modulated at low frequency.

FIG. 17 shows the voltage and current waveforms of the lamp when the power is modulated at 250 Hz. A 150 W HPS lamp was used and the capacitance of C1 was equal to 33 nF. The center frequency is equal to 55 kHz for the peak current and 12 kHz for the simmer current.

FIG. 18(a) shows the voltage and current waveforms of the lamp during the interval in which the inverter operates at the higher frequencies, emulating the peak current. During this interval the current reaches peak values of 13 A due to the high temperature of the arc.

FIG. 18(b) shows the voltage and current waveforms of the lamp when supplied at the lower frequencies, emulating the simmer current. The peak current under this operating condition is low (3.5 A) due to the high equivalent resistance of the lamp during this operating interval.

The behavior of the HPS lamps using high frequency pulsed supply and with low frequency power modulation was studied, but the influence of using pulsed supply on metal halide lamps and other types of discharge lamps was not evaluated.

Even when using supply techniques that avoid the appearance of acoustic resonance, acoustic noise emissions may still occur. The magnetoelastic phenomena and photoacoustic effects are responsible for the acoustic emissions.

The magnetoelastic effects are phenomena responsible for the deformation of magnetic materials when subjected to varying magnetic fields. The photoacoustic effect is caused by the modulation of the luminous intensity of the lamp, whose spectrum presents at least one frequency component that excites vibrational or translational modes of the gas molecule. Since the gas is in a casing of constant volume, the variations in the luminous intensity cause variations in the temperature due to the collision of gas molecules which, in turn, cause pressure oscillations.

Both the deformations of the magnetic material and the variations of pressure within the bulb can cause acoustic noise.

To quantify the levels of acoustic noise produced by the HPS lamp using high frequency pulsed supply and low frequency modulation, the lamp was placed in an anechoic chamber and a noise measuring system was used. The background noise presented a global sound pressure level of 30.57 dB, where significant contributions of frequencies below 150 Hz are present in this chamber.

Capacitor C1 of the Half-Bridge inverter was 56 nF. This value was used to exemplify the most extreme operating case with the intention of validating the low acoustic noise contribution. In order to emulate the peak current, the switching frequency of the Half-Bridge inverter was 55 kHz (average frequency value) and in order to emulate the simmer current, the average switching frequency was 12 kHz. Under this operating condition, the inverter presented a peak current of 20 A. The supply voltage was equal to 220 V and the duty cycle of the low frequency current was 40%.

FIG. 19(a) shows the acoustic noise spectrum produced by the Osram Vialox NAV-E 150 W lamp when supplied by a current modulated at 500 Hz. The global sound pressure level produced in this operating mode was 32.66 dB.

FIG. 19(b) shows the acoustic noise spectrum produced by the Osram Vialox NAV-T 150 W lamp when supplied by a current modulated at 500 Hz. The global sound pressure level produced in this operating mode was 32.86 dB. The acoustic noise level was very close to the background noise since almost all of the noise frequency components were below the audible range.

The sound emission at the frequencies close to 12 kHz were due to the operation of the inverter at this frequency during the interval which emulates the simmer current.

FIG. 20(a) and FIG. 20(b) present the spectra produced by the Osram Vialox NAV-E 150W lamp and by the Osram Vialox NAV-T 150 W, respectively, when using high frequency pulsed supply without low frequency modulation. Note that in both cases the acoustic noise produced was almost entirely below the audible range, proving that in this operation mode the lamp does not emit audible noise.

The volume of the Half-Bridge inverter suffers minor alterations with the increase in power due to the absence of the magnetic elements, which are the main culprits for the increase in volume due to the increase in power. The design of this inverter also suffered minor changes due to the variation in power, making it easily adaptable.

Applying the proposed technique is not limited only to high pressure discharge lamps; in other words, it is possible to apply this technique to low pressure discharge lamps as well as fluorescent lamps.

1) HIGH FREQUENCY PULSED SUPPLY FOR DISCHARGE LAMPS composed of an electronic converter supplied by a voltage source, not employing elements placed in series with the discharge lamp, characterized by stabilization of the current by means of peak current control of the lamp's current.

2) HIGH FREQUENCY PULSED SUPPLY FOR DISCHARGE LAMPS make possible the use of a low frequency pulsed supply by means of high frequency pulsed current modulation.

3) HIGH FREQUENCY PULSED SUPPLY FOR DISCHARGE LAMPS composed of an electronic converter supplied by a voltage source characterized by the use of a high frequency pulsed supply with current stabilization by means of a capacitive element placed in series with the discharge lamp.

4) HIGH FREQUENCY PULSED SUPPLY FOR DISCHARGE LAMPS, in agreement with claim 3, characterized by the open-loop control of the power supplied to the lamp.

5) HIGH FREQUENCY PULSED SUPPLY FOR DISCHARGE LAMPS, in agreement with claim 4, characterized by the variation of the luminous flux of the lamp (dimming) by means of varying the operating frequency of the converter.

6) HIGH FREQUENCY PULSED SUPPLY FOR DISCHARGE LAMPS, in agreement with claim 3, characterized by low frequency modulation by means of varying the frequency of the high frequency current pulses and low frequency modulation of the power supplied to the lamp.

7) HIGH FREQUENCY PULSED SUPPLY FOR DISCHARGE LAMPS composed of an electronic converter supplied by a voltage source, not employing magnetic elements placed in series with the discharge lamp, characterized by the elimination of the acoustic resonance by means of randomly varying the frequency of the high frequency current pulses over a wide frequency range.
